(19) United States
(12) Patent Application Publication
(10) Pub. No.: US 2013/0087416 A1
(43) Pub. Date: Apr. 11, 2013

(54) Brake Apparatus and Brake Shoe Retainer

(71) Applicant: Jacob Kobelt, Surrey (CA)

(72) Inventor: Jacob Kobelt, Surrey (CA)

(73) Assignee: Interkob Holdings Ltd., Surrey (CA)

(21) Appl. No.: 13/269,464

(22) Filed: Oct. 7, 2011

(51) Int. Cl. F16D 55/22; F16D 65/18

(52) U.S. Cl. 188/72.3; 188/73.31; 188/72.1; 188/72.4; 188/73.32

(57) ABSTRACT

An illustrative brake apparatus includes: a brake body; a first retaining means for retaining a brake shoe against the brake body while permitting the brake shoe to be actuated in a brake actuation direction; and a second retaining means for selectively retaining the brake shoe against lateral movement in a direction of movement of an object to be braked. An illustrative brake shoe retainer apparatus includes: first and second brake shoe connectors connectable to respective spaced apart regions of a brake shoe; a force transfer element connectable to the first and second brake shoe connectors; a guide connectable to a brake body and configured to guide the force transfer element relative to the brake body in a brake actuation direction and in a direction opposite the brake actuation direction; and a means for urging the force transfer element in the direction opposite the brake actuation direction.

### BACKGROUND OF THE INVENTION

1. Field of Invention

The invention relates generally to brakes, and more particularly to a brake apparatus and a brake shoe retainer apparatus.

2. Description of Related Art

A “direct-acting brake” may refer to a brake having an actuator that transmits a brake actuation force directly on a brake shoe, without transmitting the brake actuation force through a brake caliper.

One known direct-acting brake includes a main frame defining a plurality of through-openings, which slidably receive respective pins connected to a brake shoe. The brake shoe is actuatable in a brake actuation direction away from the main frame, and the pins slide through the respective through-openings in response to movement of the brake shoe in the brake actuation direction, or in a direction opposite the brake actuation direction. When a brake lining on the brake shoe frictionally contacts an object to be braked, a braking force urges the brake shoe in a direction of movement of the object to be braked. The brake shoe transmits the braking force to one or more of the pins, which transmit the braking force to the main frame. However, unless the through-openings and pins are very precisely machined, the pins will not bear the braking force evenly, and the main frame and the pins may thus disadvantageously wear unevenly. Further, if the brake shoe expands or contracts due to thermal expansion or contraction of one or more of the aforementioned components, one or more of the pins may become seized in their respective through-openings, thus disadvantageously seizing the brake. Further, some known direct-acting brakes disadvantageously require significant and time-consuming disassembly and reassembly to install and remove a brake shoe.

### SUMMARY OF THE INVENTION

In accordance with one illustrative embodiment, there is provided a brake apparatus including: a first brake body; a first retaining means for retaining a first brake shoe against the first brake body while permitting the first brake shoe to be actuated in a brake actuation direction, away from the first brake body, to cause an outer frictional contact surface of a first brake lining connected to the first brake shoe to contact frictionally an object to be braked; and a second retaining means for selectively retaining the first brake shoe against lateral movement in a direction of movement of the object to be braked.

The apparatus may further include a means for actuating the first brake shoe in the brake actuation direction.

The means for actuating may include a brake piston for transmitting a brake actuation force directly on the first brake shoe.

The first retaining means may include a means for resiliently urging the first brake shoe against the first brake body.

The apparatus may further include the first brake shoe.

The first retaining means may be configured to retain the first brake shoe with a lateral space between the first brake shoe and the second retaining means while permitting the first brake shoe to move towards and contact the second retaining means when the first brake shoe is urged in the direction of movement of the object to be braked.

The second retaining means may include at least one retainer body removably connectable to the first brake body.

The at least one retainer body may include a key having a connecting portion and a retaining portion, and the first brake body may define a recess for attachably receiving the connecting portion to connect the key removably to the first brake body.

Each one of the at least one retainer body may include a threaded portion and a retaining portion, and the first brake body may define at least one threaded opening for attachably receiving the threaded portion of a respective one of the at least one retainer body to connect the respective one of the at least one retainer body removably to the first brake body.

The first brake body may be configured to permit the first brake shoe to be installed in or removed from the brake apparatus generally in the direction of movement of the object to be braked when the second retaining means does not retain the first brake shoe against lateral movement in the direction of movement of the object to be braked.

The apparatus may further include a brake frame including: the first brake body; and a second brake body connectable to a second brake shoe connected to a second brake lining having an outer frictional contact surface. The brake frame may define a recess between the first and second brake bodies, and the first and second brake shoes may be positionable in the recess such that the respective outer frictional contact surfaces of the first and second brake linings are opposite each other in the recess generally perpendicular to the brake actuation direction.

The recess may be sized to receive at least a portion of a rotatable disc having first and second generally circular opposite sides, and the first and second brake shoes may be positionable in the recess such that the first and second brake linings are positionable apart from the first and second generally circular opposite sides respectively of the rotatable disc when the first brake shoe is not actuated in the brake actuation direction and such that the respective outer frictional contact surfaces of the first and second brake linings are positionable in frictional contact with the first and second generally circular opposite sides respectively of the rotatable disc when the first brake shoe is actuated in the brake actuation direction.

The frame may include a means for mounting the frame slidably in a direction generally parallel to the brake actuation direction.

In accordance with another illustrative embodiment, there is provided a brake apparatus including: a first brake body; a brake shoe retainer for retaining a first brake shoe against the first brake body while permitting the first brake shoe to be actuated in a brake actuation direction, away from the first brake body, to cause an outer frictional contact surface of a first brake lining connected to the first brake shoe to contact frictionally an object to be braked; and a lateral retainer for selectively contacting the first brake shoe to retain the first brake shoe selectively against lateral movement in a direction of movement of the object to be braked.

The apparatus may further include an actuator connectable to the first brake body for actuating the first brake shoe in the brake actuation direction.

The actuator may include a brake piston for transmitting a brake actuation force directly from the actuator to the first brake shoe.

The brake shoe retainer may be configured to urge the first brake shoe resiliently against the first brake body.

The apparatus may further include the first brake shoe.

The brake shoe retainer may be configured to retain the first brake shoe with a lateral space between the first brake shoe and the lateral retainer while permitting the first brake shoe to move towards and contact the lateral retainer when the first brake shoe is urged in the direction of movement of the object to be braked.

The lateral retainer may include at least one retainer body removably connectable to the first brake body.

The at least one retainer body may include a key having a connecting portion and a retaining portion, and the first brake body may define a recess for attachably receiving the connecting portion to connect the key removably to the first brake body.

Each one of the at least one retainer body may include a threaded portion and a retaining portion, and the first brake body may define at least one threaded opening for attachably receiving the threaded portion of a respective one of the at least one retainer body to connect the respective one of the at least one retainer body removably to the first brake body.

The first brake body may be configured to permit the first brake shoe to be installed in or removed from the brake apparatus generally in the direction of movement of the object to be braked when the lateral retainer does not retain the first brake shoe against lateral movement in the direction of movement of the object to be braked.

The apparatus may further include a brake frame including: the first brake body; and a second brake body connectable to a second brake shoe connected to a second brake lining having an outer frictional contact surface. The brake frame may define a recess between the first and second brake bodies, and the first and second brake shoes may be positionable in the recess such that the respective outer frictional contact surfaces of the first and second brake linings are opposite each other in the recess generally perpendicular to the brake actuation direction.

The recess may be sized to receive at least a portion of a rotatable disc having first and second generally circular opposite sides, and the first and second brake shoes may be positionable in the recess such that the first and second brake linings are positionable apart from the first and second generally circular opposite sides respectively of the rotatable disc when the first brake shoe is not actuated in the brake actuation direction and such that the respective outer frictional contact surfaces of the first and second brake linings are positionable in frictional contact with the first and second generally circular opposite sides respectively of the rotatable disc when the first brake shoe is actuated in the brake actuation direction.

The frame may include a slide bearing for mounting the frame slidably in a direction generally parallel to the brake actuation direction.

In accordance with another illustrative embodiment, there is provided a brake shoe retainer apparatus including: first and second brake shoe connectors connectable to respective spaced apart regions of a brake shoe; a force transfer element connectable to the first and second brake shoe connectors; a guide connectable to a brake body and configured to guide the force transfer element relative to the brake body in a brake actuation direction and in a direction opposite the brake actuation direction; and a means for urging the force transfer element in the direction opposite the brake actuation direction.

The first brake connector may include a first shaft and a first end stop on an end of the first shaft. The second brake connector may include a second shaft and a second end stop on an end of the second shaft. The first and second end stops may have respective widths. The force transfer element may have opposite inward-facing and outward-facing surfaces. The force transfer element may define first and second through-openings, extending between the inward-facing and outward-facing surfaces, for receiving the respective shafts of the first and second brake shoe connectors respectively. The first and second through-openings may have respective widths less than the widths of the first and second end stops respectively, such that the force transfer element can retain at least respective portions of the first and second end stops against the outward-facing surface to prevent the first and second end stops from passing through the first and second through-openings respectively when the first and second through-openings receive the first and second shafts respectively.

The width of the first through-opening may be greater than a width of the first shaft, and the width of the second through-opening may be greater than a width of the second shaft, such that when the first and second brake shoe connectors are connected to the brake shoe and connected to the force transfer element, the first and second brake shoe connectors are movable relative to the force transfer element to accommodate movement of the brake shoe relative to the force transfer element.

The guide may include a post having a longitudinal axis, and the force transfer element may define a third through-opening generally complementary to the post.

The first and second through-openings may be on respective opposite ends of the force transfer element, and the third through-opening may be between the first and second through-openings.

The first through-opening may extend to a first side of the force transfer element and the second through-opening may extend to a second side of the force transfer element opposite the first side of the force transfer element. The force transfer element may be rotatable about the post such that the first and second shafts are receivable in and removable from the first and second through openings respectively in response to rotation of the force transfer element about the post.

The first brake connector may further include a first inner stop positionable against the inward-facing surface of the force transfer element when the first through-opening receives the first shaft. The second brake connector may further include a second inner stop positionable against the inward-facing surface of the force transfer element when the second through-opening receives the second shaft.

The means for urging may include a resilient body positionable in contact with the force transfer element and the brake body.

The resilient body may include a coil spring positionable around a portion of the guide.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings of illustrative embodiments:

FIG. 1 is a side view of a brake system according to an illustrative embodiment;

FIG. 2 is a front oblique view of a first brake assembly of the brake system of FIG. 1;

FIG. 3 is a top view of the brake assembly of FIG. 2;

FIG. 4 is a partially exploded rear oblique view of the brake assembly of FIG. 2;

FIG. 5 is a front oblique view of a brake body of the brake assembly of FIG. 2;

FIG. 6 is an oblique view of a brake shoe and a brake lining of the brake assembly of FIG. 2;

FIG. 7 is a cross-sectional view of the brake assembly of FIG. 2 taken along the line VII-VII in FIG. 4;

FIG. 8 is an oblique view of a lateral retainer of the brake assembly of FIG. 2;

FIG. 9 is a top view of the brake body of FIG. 5;

FIG. 10 is a front oblique view of a brake body of a second brake assembly of the brake system of FIG. 1;

FIG. 11 is a rear oblique view of the brake body of FIG. 10;

FIG. 12 is an oblique view of a center brake body of the brake system of FIG. 1;

FIG. 13 is an oblique view of a brake body according to another illustrative embodiment;

FIG. 14 is a partially exploded rear oblique view of a brake assembly according to another illustrative embodiment;

FIG. 15 is an oblique view of a brake shoe and a brake lining of the brake assembly of FIG. 14;

FIG. 16 is a cross-sectional view of the brake assembly of FIG. 14 taken along the line XVI-XVI in FIG. 14; and

FIG. 17 is a plan view of a force transfer element of the brake assembly of FIG. 14.

### DETAILED DESCRIPTION

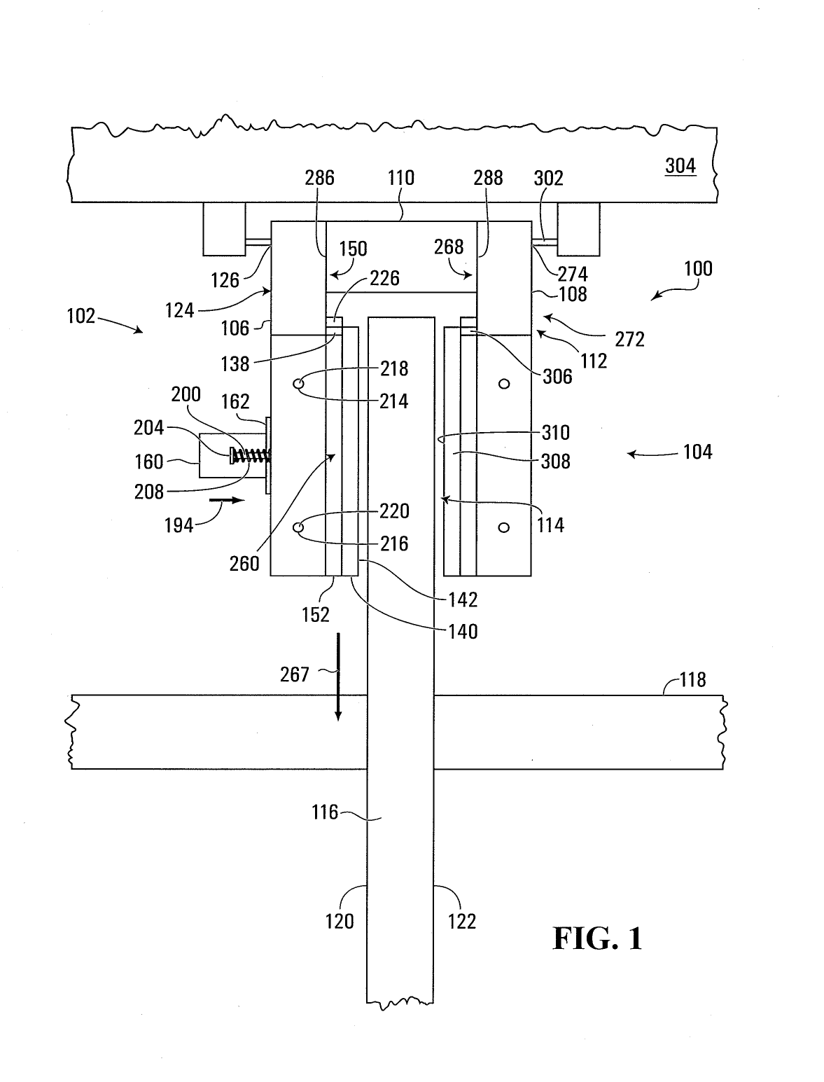

Referring to FIG. 1, a brake system according to an illustrative embodiment is shown generally at 100. The brake system 100 includes a first brake assembly shown generally at 102, and a second brake assembly shown generally at 104. The first brake assembly 102 includes a first brake body 106, and the second brake assembly 104 includes a second brake body 108. The brake system 100 also includes a center brake body 110 between the first brake body 106 and the second brake body 108, and the first brake body 106, the second brake body 108, and the center brake body 110 form a brake frame shown generally at 112.

The brake frame 112 defines a recess shown generally at 114 between the first brake body 106 and the second brake body 108. In the embodiment shown, the recess 114 is sized to receive a portion of a rotatable disc 116 rotatable about a rotatable shaft 118. The rotatable disc 116 has first and second opposite side surfaces 120 and 122. The opposite side surfaces 120 and 122 may be referred to as “generally circular” because the rotatable disc 116 may be either exactly circular, or approximately and sufficiently circular such that the brake system 100 functions as a disc brake to brake an object to be braked, which in the embodiment shown is the rotatable disc 116.

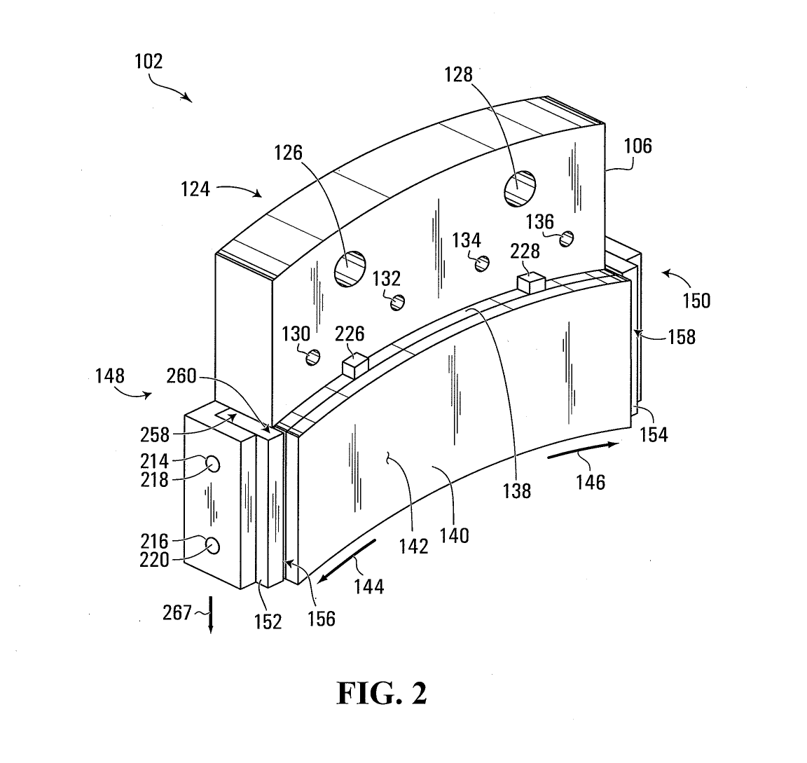

Referring to FIG. 2, the first brake body 106 in the embodiment shown includes a generally planar mounting flange shown generally at 124 and having slide bearings 126 and 128. The mounting flange 124 also defines through-openings 130, 132, 134, and 136 for receiving respective fasteners (not shown) to connect the first brake body 106 to the second brake body 108 and to the center brake body 110 (shown in FIG. 1).

The first brake assembly 102 in the embodiment shown also includes a first brake shoe 138 connected to a first brake lining 140. In the embodiment shown, the first brake shoe 138 includes a metallic plate, and the first brake lining 140 has an outer frictional contact surface 142 for frictionally contacting the first generally circular side surface 120 of the rotatable disc 116 (shown in FIG. 1).

When the rotatable disc 116 rotates about the rotatable shaft 118, the first generally circular side surface 120 of the rotatable disc 116 (shown in FIG. 1) moves relative to the outer frictional contact surface 142 either in a direction shown by the arrow 144, or in a direction shown by the arrow 146 opposite the direction shown by the arrow 144. In the embodiment shown, the directions of the arrows 144 and 146 may be referred to as lateral directions towards respective first and second laterally opposite sides shown generally at 148 and 150 of the first brake assembly 102. The first brake assembly 102 also includes first and second lateral retainers 152 and 154.

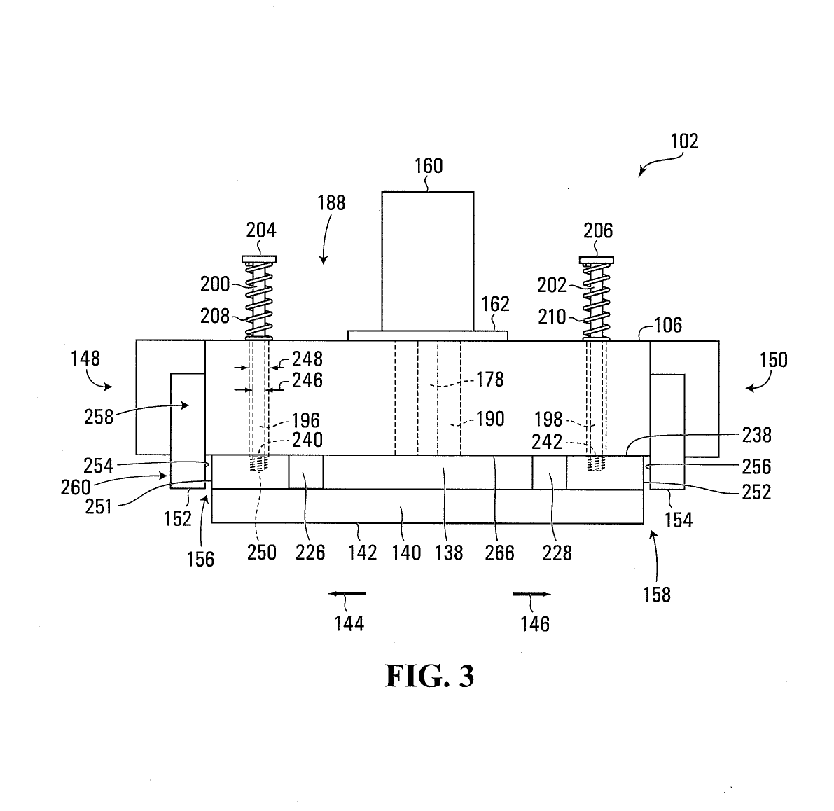

Referring to FIG. 3, in the first brake assembly 102, a first lateral space shown generally at 156 separates the first brake shoe 138 from the first lateral retainer 152, and a second lateral space shown generally at 158 separates the first brake shoe 138 from the second lateral retainer 154. The first and second lateral spaces 156 and 158 may advantageously accommodate thermal expansion of the first brake shoe 138 in response to elevated temperatures of the first brake shoe 138 caused by frictional contact of the outer frictional contact surface 142 with the first generally circular side surface 120 of the rotatable disc 116 (shown in FIG. 1), for example. However, in alternative embodiments, the first and second lateral spaces 156 and 158 may be omitted, and the first brake shoe 138 may directly contact the first and second lateral retainers 152 and 154.

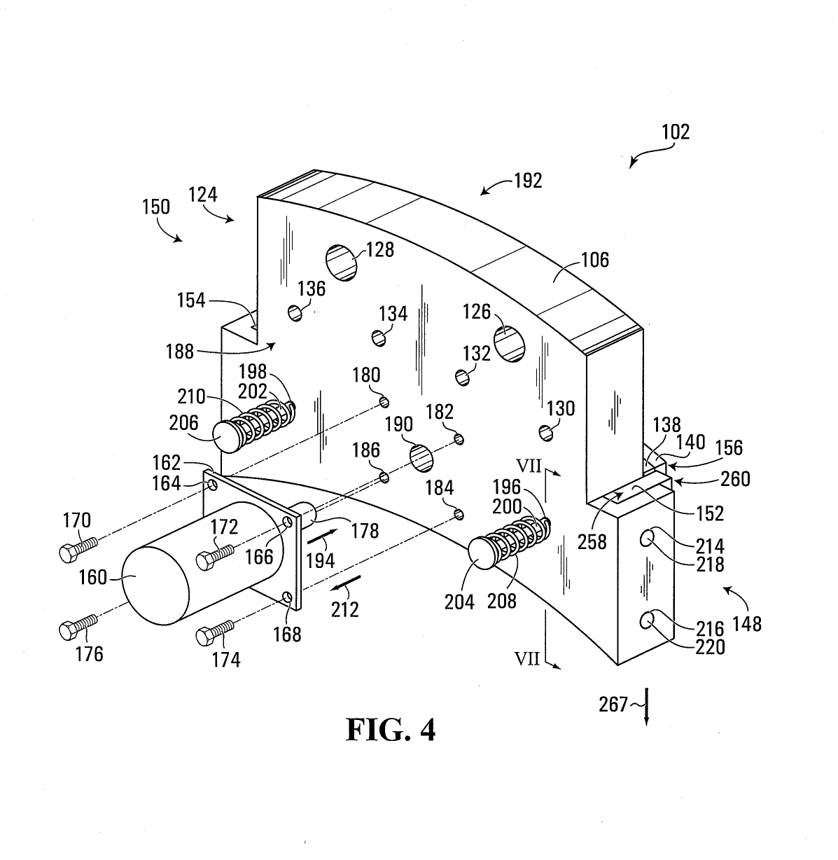

Referring to FIG. 4, the first brake assembly 102 also includes a brake actuator 160, which can include one or more known actuator devices such as a piston actuatable by pneumatic or hydraulic fluid, for example. The brake actuator 160 in the embodiment shown includes a mounting flange 162 defining a plurality of through-openings including the through-openings 164, 166, and 168. In the embodiment shown, the through-openings in the mounting flange 162 receive respective threaded fasteners 170, 172, 174, and 176 to connect the brake actuator 160 to the first brake body 106. The brake actuator 160 also includes a brake piston 178 for transmitting a brake actuation force to the first brake shoe 138.

In the embodiment shown, the first brake body 106 defines threaded openings 180, 182, 184, and 186 to receive respective portions of the threaded fasteners 170, 172, 174, and 176 respectively in a rear side shown generally at 188. The first brake body 106 also defines a through-opening 190 extending between the rear side 188 and a front side shown generally at 192, and the through-opening 190 in the embodiment shown receives the brake piston 178 to facilitate contact of the brake piston 178 against the first brake shoe 138.

The first brake body 106 also defines through-openings 196 and 198 both extending between the rear side 188 and the front side 192. The through-openings 196 and 198 in the embodiment shown receive respective portions of first and second brake shoe connectors 200 and 202 respectively, which are connectable to respective spaced apart regions of the first brake shoe 138. At respective rear ends, the first and second brake shoe connectors 200 and 202 have respective stops 204 and 206. The first brake assembly 102 includes first and second coil springs 208 and 210 positioned between the rear side 188 of the first brake body 106 and the first and second stops 204 and 206 respectively. The first and second coil springs 208 and 210 are resiliently compressed in the embodiment shown in FIG. 4, such that the springs resiliently urge the stops 204 and 206, and thus the first and second brake shoe connectors 200 and 202, in a direction shown by the arrow 212 opposite the brake actuation direction of the arrow 194.

On the first lateral side 148 of the first brake assembly 102, the first brake body 106 defines first and second openings 214 and 216 for receiving respective fasteners 218 and 220. In the embodiment shown, the fasteners 218 and 220 are connectable to the first lateral retainer 152, and thus removably connect the first lateral retainer 152 to the first brake body 106. Corresponding through-openings and fasteners (not shown) removably connect the second lateral retainer 154 to the first brake body 106.

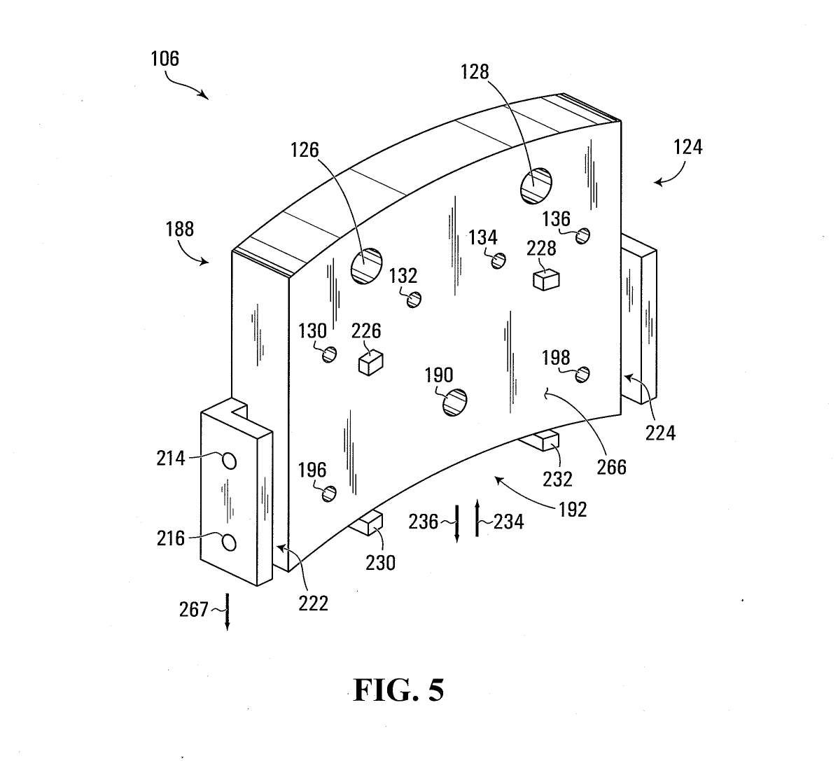

Referring to FIG. 5, on the front side 192, the first brake body 106 defines a first transverse elongate recess 222 for receiving a portion of the first lateral retainer 152 (shown in FIGS. 2 and 3, for example), and a second transverse elongate recess 224 for receiving a portion of the second lateral retainer 154 (also shown in FIGS. 2 and 3, for example). Further, on the front side 192, the first brake body 106 has a plurality of radial brake shoe retainers 226, 228, 230, and 232, which in the embodiment shown collectively retain the first brake shoe 138 (shown in FIG. 2, for example) against movement in radial directions (such as the radial directions shown by the arrows 234 and 236, for example) when the first brake shoe 138 is retained against the front side 192 of the first brake body 106 between the radial brake shoe retainers 226, 228, 230, and 232.

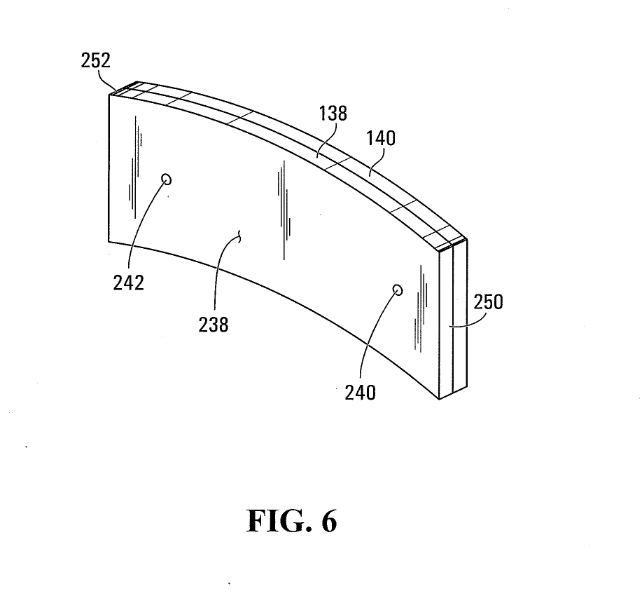

Referring to FIGS. 4 and 6, the first brake shoe 138 has a rear surface 238. In the embodiment shown, the brake piston 178 is received in the through-opening 190 of the first brake body 106 when the brake actuator 160 is connected to the rear side 188 of the first brake body 106, and the brake piston 178 selectively contacts the rear surface 238 of the first brake shoe 138 to apply selectively a brake actuation force on the first brake shoe 138 in the brake actuation direction of the arrow 194. In the embodiment shown, the brake piston 178 transmits a brake actuation force in a brake actuation direction of the arrow 194 directly on the first brake shoe 138. The first brake assembly 102 may thus be referred to as a “direct-acting” brake assembly.

Referring to FIG. 6, in the embodiment shown, the first brake shoe 138 defines first and second spaced apart threaded openings 240 and 242 for receiving respective threaded ends of the first and second brake shoe connectors 200 and 202 respectively (shown in FIG. 4) and connecting the first and second brake shoe connectors 200 and 202 to the first brake shoe 138. The first and second threaded openings 240 and 242 are in respective regions of the rear surface 238 of the first brake shoe 138 such that when the first brake shoe 138 is received against the front side 192 of the first brake body 106 as shown in FIGS. 2 and 3 for example, the first and second threaded openings 240 and 242 are aligned with the through-openings 196 and 198 respectively to permit the first and second brake shoe connectors 200 and 202 to pass through the through-openings 196 and 198 respectively to be received in the first and second threaded openings 240 and 242 respectively.

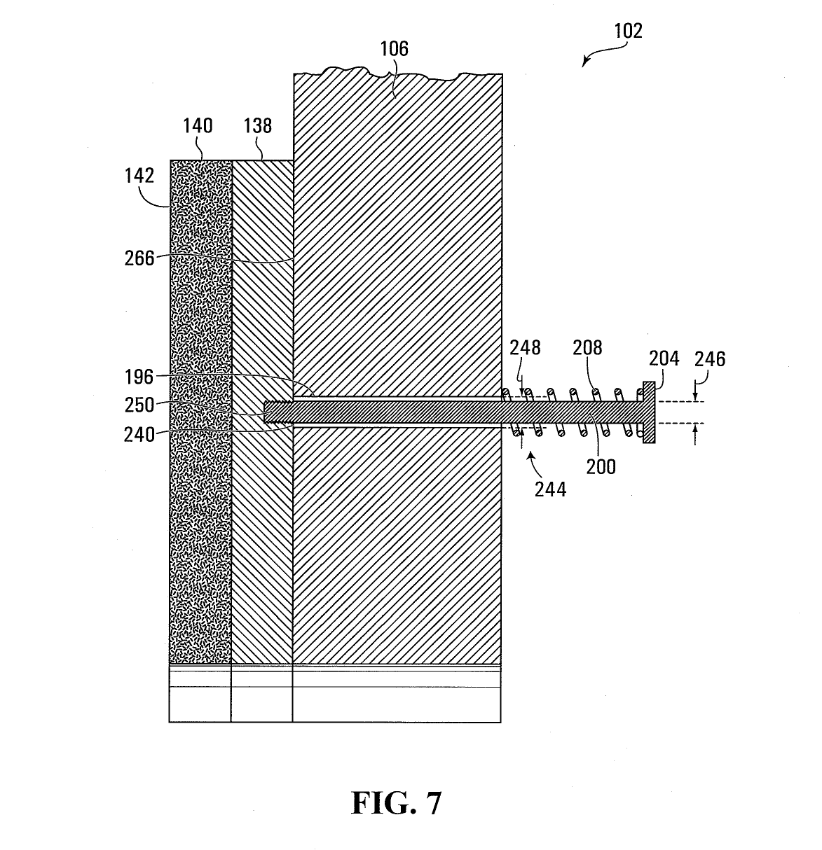

Referring to FIG. 7, the first brake shoe connector 200 includes a shaft portion shown generally at 244 that passes through the through-opening 196 and has a width 246. The through-opening 196 has a width 248, which in the embodiment shown is greater than the width 246. The first brake shoe connector 200 has a threaded end 250 threadedly receivable in the first threaded opening 240 of the first brake shoe 138. The second brake shoe connector 202, the through-opening 198, and the second threaded opening 242 (shown in FIGS. 4 and 6 for example) are substantially the same as the first brake shoe connector 200, the through-opening 196, and the first threaded opening 240 respectively.

Referring back to FIG. 4, the first and second coil springs 208 and 210 retain the first brake shoe 138 against the front side 192 of the first brake body 106. However, the first and second coil springs 208 and 210 are further resiliently compressible, and thus when the brake piston 178 transmits a brake actuation force in the brake actuation direction of the arrow 194 on the first brake shoe 138, the first brake shoe 138 is actuated in the brake actuation direction away from the first brake body 106.

When the brake piston 178 moves in the direction of the arrow 212 opposite the brake actuation direction and thus ceases transmitting a brake actuation force on the first brake shoe 138, the first and second coil springs 208 and 210 expand to urge the first and second brake shoe connectors 200 and 202, and thus the first brake shoe 138, in the direction of the arrow 212 opposite the brake actuation direction again to retain the first brake shoe 138 against the front side 192 of the first brake body 106. The first and second brake shoe connectors 200 and 202 and the first and second coil springs 208 and 210 in the embodiment shown thus function as a brake shoe retainer to retain the first brake shoe 138 against the first brake body 106 while permitting the first brake shoe 138 to be actuated in the brake actuation direction of the arrow 194, away from the first brake body 106. Further, the first and second coil springs 208 and 210 in the embodiment shown resiliently urge the first brake shoe 138 against the first brake body 106.

Referring back to FIG. 1, when the brake actuator 160 transmits a brake actuation force on the first brake shoe 138 in the brake actuation direction of the arrow 194, the outer frictional contact surface 142 of the first brake lining 140 contacts the first generally circular side surface 120 of the rotatable disc 116, thereby frictionally contacting the rotatable disc 116. The first brake assembly 102 may thus be referred to as a “brake apparatus” and the rotatable disc 116 may be referred to as an “object to be braked”. In alternative embodiments, objects to be braked need not be limited to rotatable discs.

Referring to FIG. 3, when the outer frictional contact surface 142 frictionally contacts the rotatable disc 116, the first brake shoe 138 is urged in a direction of motion of the rotatable disc 116, such as the radial direction of motion shown by the arrow 144 or by the arrow 146. In the embodiment shown, because the width 248 is greater than the width 246, and because the first brake shoe 138 is spaced apart from the first and second lateral retainers 152 and 154 by the first and second lateral spaces 156 and 158 respectively, the first brake shoe 138 is moveable in the direction of motion shown by the arrow 144 or 146 such that a first lateral edge 251 of the first brake shoe 138 contacts the first lateral retainer 152 when the first brake shoe 138 is urged in the direction of the arrow 144, and a second lateral edge 252 of the first brake shoe 138 contacts the second lateral retainer 154 when the first brake shoe 138 is urged in the direction of the arrow 146. The first and second brake shoe connectors 200 and 202 and the first and second coil springs 208 and 210 thus retain the first brake shoe 138 against the first brake body 106 with one or both of the first and second lateral spaces 156 and 158 between the first brake shoe 138 and the first and second lateral retainers 152 and 154 respectively, while permitting the first brake shoe 138 to move towards and contact the first lateral retainer 152 or the second lateral retainer 154 when the first brake shoe 138 is urged in the direction of the arrow 144 in the direction of the arrow 146 respectively. The first brake shoe 138 therefore may selectively contact one of the first and second lateral retainers 152 and 154.

Because the first and second lateral retainers 152 and 154 retain the first brake shoe 138 against lateral movement in the directions of the arrows 144 and 146, and because the first and second brake shoe connectors 200 and 202 permit lateral movement of the first brake shoe 138 for the first brake shoe 138 to contact one of the first and second lateral retainers 152 and 154, it is not necessary to machine the components of the first brake assembly 102 as precisely as may be required in other brake assemblies. In the embodiment shown, lateral contact surfaces 254 and 256 of the first and second lateral retainers respectively provide relatively large surface areas to retain the first brake shoe 138 against lateral braking forces without requiring machining of such components as precisely as may be required to provide similar surface areas for laterally retaining the first brake shoe 138 against such lateral braking forces in other brake assemblies. Further, the surface areas of the lateral contact surfaces 254 and 256 are unaffected by thermal expansion or contraction of the first brake shoe 138, and thus the first brake assembly 102 may be less likely to seize in response to thermal expansion of the first brake shoe 138 when compared to other brake assemblies.

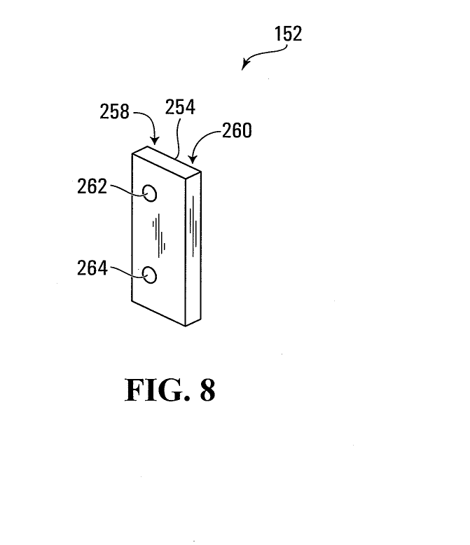

Referring to FIG. 8, the first lateral retainer 152 in the embodiment shown includes a retainer body (that may also be referred to as a “key”) having a connecting portion shown generally at 258 and a retaining portion shown generally at 260. The connecting portion 258 defines threaded openings 262 and 264 for receiving the fasteners 218 and 220 respectively (shown in FIGS. 1, 2, and 4). The connecting portion 258 in the embodiment shown is sized to be received within the first transverse elongate recess 222 shown in FIG. 5, and the first lateral retainer 152 is sized such that the retaining portion 260 projects from the first transverse elongate recess 222 when the connecting portion 258 is received in the first transverse elongate recess 222 such that the contact surface 254 is positioned to contact the first lateral edge 251 of the first brake shoe 138 when the first brake assembly 102 is assembled as shown in FIG. 3, for example. The fasteners 218 and 220 (shown in FIGS. 1, 2, and 4) permit the first lateral retainer 152 to be attached to the first brake body 106, and the first lateral retainer 152 is thus removably connectable to the first brake body 106. The second lateral retainer 154 and the second transverse elongate recess 224 (shown in FIGS. 2 to 5) are substantially the same as the first lateral retainer 152 and the first transverse elongate recess 222 respectively.

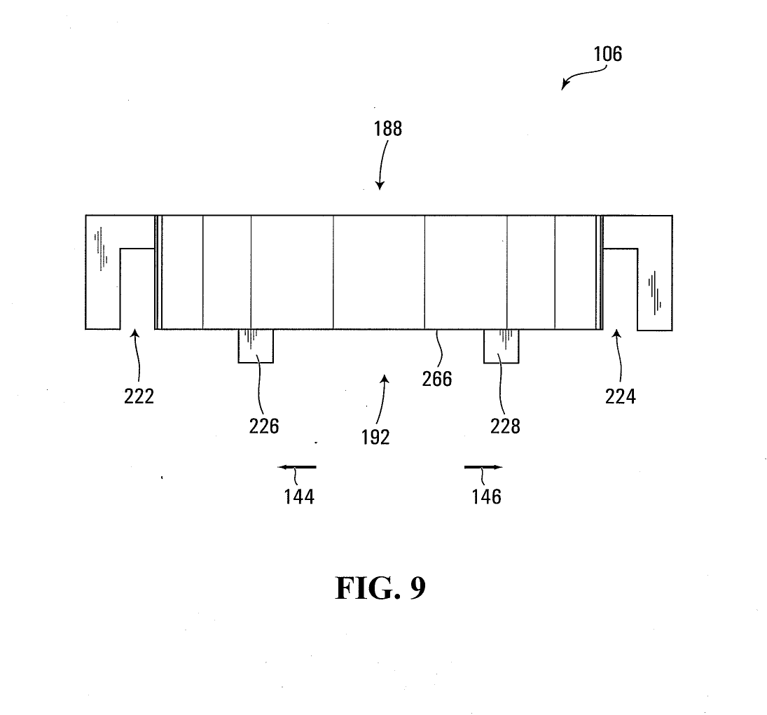

Referring to FIGS. 3 and 9, the first brake body 106 has a generally planar front surface 266 for contacting the rear surface 238 of the first brake shoe 138. Therefore, when the first and second lateral retainers 152 and 154 are removed from the first brake body 106, the first brake shoe 138 and the first brake lining 140 may be removed from the first brake assembly 102 in the direction of movement of the rotatable disc 116 (shown in FIG. 1), which may include the radial direction of the arrow 144 or of the arrow 146, for example.

Referring back to FIG. 1, the first lateral retainer 152 may be removed by removing the fasteners 218 and 220 thus disconnecting the first lateral retainer 152 from the first brake body 106, removing the first lateral retainer 152 from the first transverse elongate recess 222 (shown in FIGS. 5 and 9, for example) by moving the first lateral retainer 152 in the direction of the arrow 267 for example, and then by moving the first brake shoe 138 in the direction of the arrow 144 or of the arrow 146 for example. Therefore, the first brake shoe 138 may be removed from the first brake assembly 102 simply by removing the first lateral retainer 152 (or alternatively the second lateral retainer 154 shown in FIGS. 2 and 3 for example) and by disconnecting the first and second brake shoe connectors 200 and 202 from the first brake shoe 138, but without time-consuming disassembly and assembly that may be required in other brake assemblies.

More generally, in the embodiment shown in FIG. 1, the first brake shoe 138 and the first brake lining 140 may be removed from the first brake assembly 102 generally in a direction of movement of an object to be braked (such as the directions of the arrow 144 or of the arrow 146, for example), meaning either in the direction of movement of the object to be braked, or approximately in the direction of movement of the object to be braked as may be permitted by removing a lateral retainer (such as one of the first and second lateral retainers 152 and 154, for example), and by disconnecting the first and second brake shoe connectors 200 and 202 from the first brake shoe 138, but without requiring further disassembly of the brake system 100. In the embodiment shown in FIG. 1, the radial brake shoe retainers 226, 228, 230, and 232 guide the first brake shoe 138 for such removal generally in the direction of movement of the object to be braked, and thus the first brake body 106 is configured to permit the first brake shoe 138 to be installed in or removed from the first brake assembly 102 generally in the direction of movement of the object to be braked when one of the first and second lateral retainers 152 and 154 is removed from the first brake assembly 102.

Further, because the first and second lateral retainers 152 and 154 are connectable to and removable from the first brake assembly 102, one or both or the first and second lateral retainers 152 and 154 can selectively retain the first brake shoe 138 against lateral movement in a direction of movement of an object to be braked, such as the rotatable disc 116 for example.

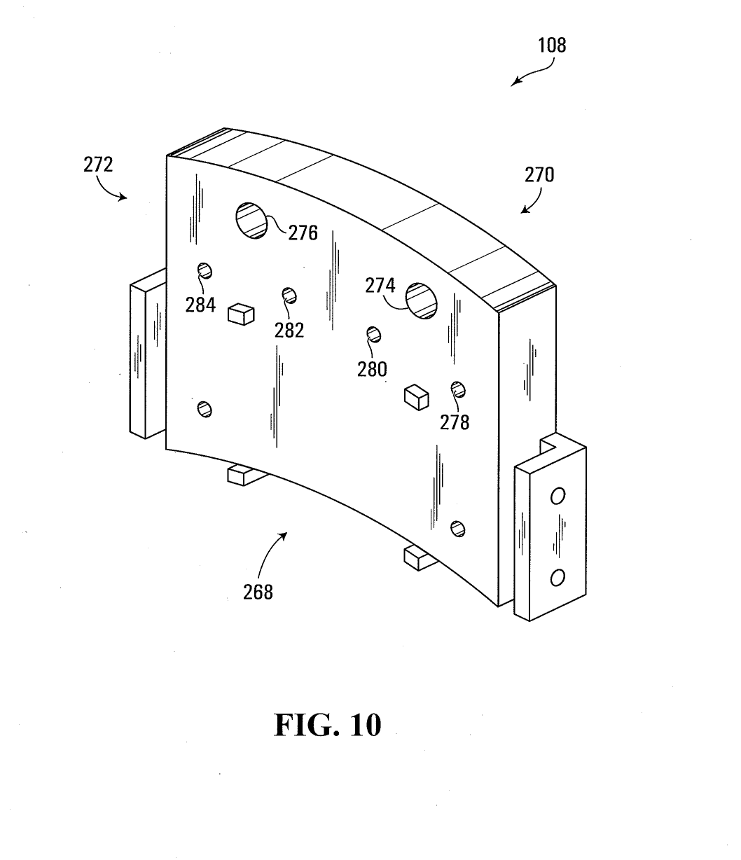

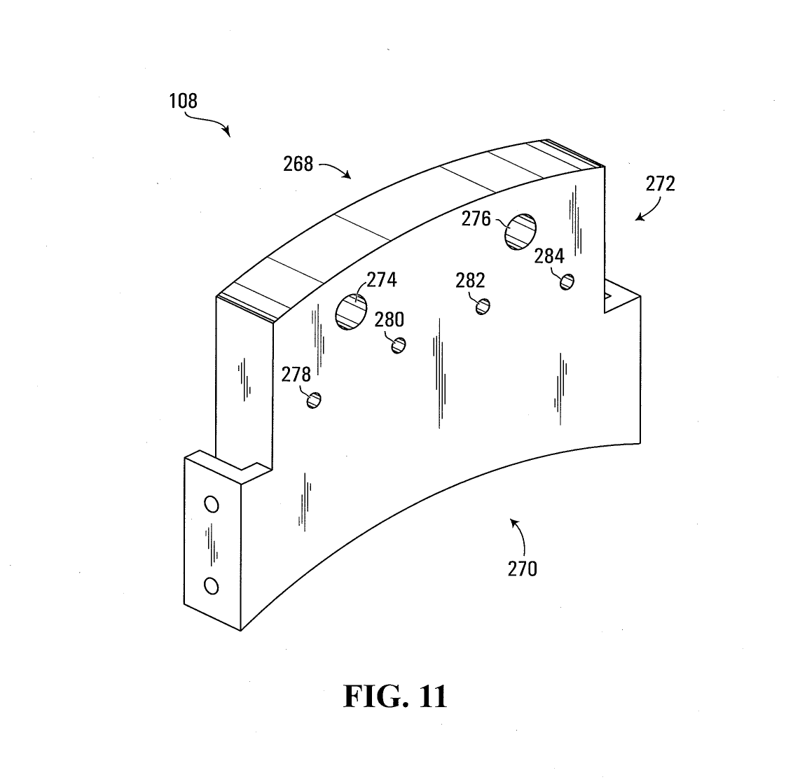

Referring to FIGS. 10 and 11, the second brake body 108 is substantially the same as the first brake body 106, although the second brake body 108 does not define a though-opening to receive a brake piston and does not define threaded openings for connecting a brake actuator to the second brake body 108. The second brake body 108 has a front side shown generally at 268 and a rear side shown generally at 270. The second brake body 108 also has a generally planar mounting flange shown generally at 272 that is substantially the same as the mounting flange 124 of the first brake body 106. The mounting flange 272 defines slide bearings 274 and 276 that are substantially aligned with the slide bearings 126 and 128 respectively of the first brake body 106 (shown in FIGS. 2, 4, and 5), and the mounting flange 272 also defines through-openings 278, 280, 282, and 284 that are substantially aligned with the through-openings 130, 132, 134, and 136 respectively of the first brake body 106 (shown in FIGS. 2, 4, and 5).

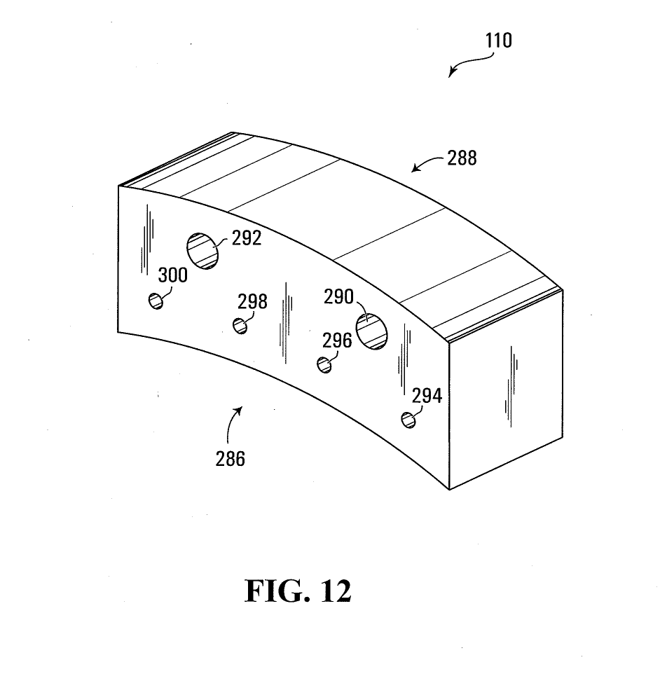

Referring to FIG. 12, the center brake body 110 has first and second opposite sides 286 and 288, slide bearings 290 and 292 extending between the first and second opposite sides 286 and 288, and through-openings 294, 296, 298, and 300 extending between the first and second opposite sides 286 and 288. The slide bearings 290 and 292 of the center brake body 110 are substantially aligned with the slide bearings 126 and 128 respectively of the first brake body 106 (shown in FIGS. 2, 4, and 5), and with the slide bearings 274 and 276 respectively of the second brake body 108 (shown in FIGS. 10 and 11). Also, the through-openings 294, 296, 298, and 300 of the center brake body 110 are substantially aligned with the through-openings 130, 132, 134, and 136 respectively of the first brake body 106 (shown in FIGS. 2, 4, and 5), and with the through-openings 278, 280, 282, and 284 respectively of the second brake body 108 (shown in FIGS. 10 and 11).

Referring back to FIG. 1, the brake system 100 may be assembled with the first side 286 of the center brake body 110 adjacent the mounting flange 124 on the front side 192 of the first brake body 106, and with the second side 288 of the center brake body 110 adjacent the mounting flange 272 on the front side 268 of the second brake body 108. The slide bearing 126 (shown in FIGS. 2, 4, and 5), the slide bearing 274 (shown in FIGS. 10 and 11), and the slide bearing 290 (shown in FIG. 12) all receive a first shaft 302 generally complementary to those slide bearings and fixed to a stationary object 304, and the slide bearing 128 (shown in FIGS. 2, 4, and 5), the slide bearing 276 (shown in FIGS. 10 and 11), and the slide bearing 292 (shown in FIG. 12) receive a second shaft (not shown) generally complementary to those slide bearings, also fixed to the stationary object 304, and parallel to the first shaft 302. The brake frame 112 is thus mounted to the stationary object 304 slidably along the first and second shafts. In the embodiment shown, first and second shafts extend longitudinally generally parallel to the brake actuation direction of the arrow 194, meaning that the first and second shafts either extend longitudinally parallel to the brake actuation direction of the arrow 194, or sufficiently close to parallel to the brake actuation direction of the arrow 194 such that the brake system 100 can effectively function in operation as described below. Therefore, the brake frame 112 is slidably mounted to the stationary object 304 in a direction generally parallel to the brake actuation direction.

Still referring to FIG. 1, the second brake assembly 104 also includes a second brake shoe 306 and a second brake lining 308 connected to the second brake shoe 306 and having an outer frictional contact surface 310. The second brake shoe 306 and the second brake lining 308 are substantially the same as the first brake shoe 138 and the first brake lining 140 respectively. The outer frictional contact surfaces 142 and 310 face into the recess opposite each other and face, respectively, the first and second generally circular side surfaces 120 and 122 of the rotatable disc 116.

Further, the outer frictional contact surfaces 142 and 310 in the embodiment shown are generally perpendicular the brake actuation direction of the arrow 194, meaning that the outer frictional contact surfaces 142 and 310 are either perpendicular the brake actuation direction of the arrow 194, or sufficiently perpendicular such that the brake system 100 functions as a brake to brake an object to be braked, which in the embodiment shown is the rotatable disc 116.

In operation, when the first brake shoe 138 is retained against the front side 192 of the first brake body 106 and not actuated in the brake actuation direction of the arrow 194, the outer frictional contact surface 142 of the first brake lining 140 is spaced apart from the first generally circular side surface 120 of the rotatable disc 116, and the outer frictional contact surface 310 of the second brake lining 308 is spaced apart from the second generally circular side surface 122 of the rotatable disc 116. The rotatable disc 116 and the rotatable shaft 118 may thus rotate without braking force from the brake system 100. However, when the brake actuator 160 actuates the first brake shoe 138 in the brake actuation direction of the arrow 194, the outer frictional contact surface 142 of the first brake lining 140 approaches and eventually frictionally contacts the first generally circular side surface 120 of the rotatable disc 116. As the brake actuator 160 continues to actuate the first brake shoe 138 in the brake actuation direction of the arrow 194, the brake system 100 slides relative to the stationary object 304 in a direction opposite the brake actuation direction of the arrow 194 until the outer surface 310 of the second brake lining 308 frictionally contacts the second generally circular side surface 122 of the rotatable disc 116. The combined frictional contact of the outer frictional contact surfaces 142 and 310 brakes, and thus retards or prevents rotation of, the rotatable disc 116 and the rotatable shaft 118. Such braking may be released by releasing brake actuation of the brake actuator 160.

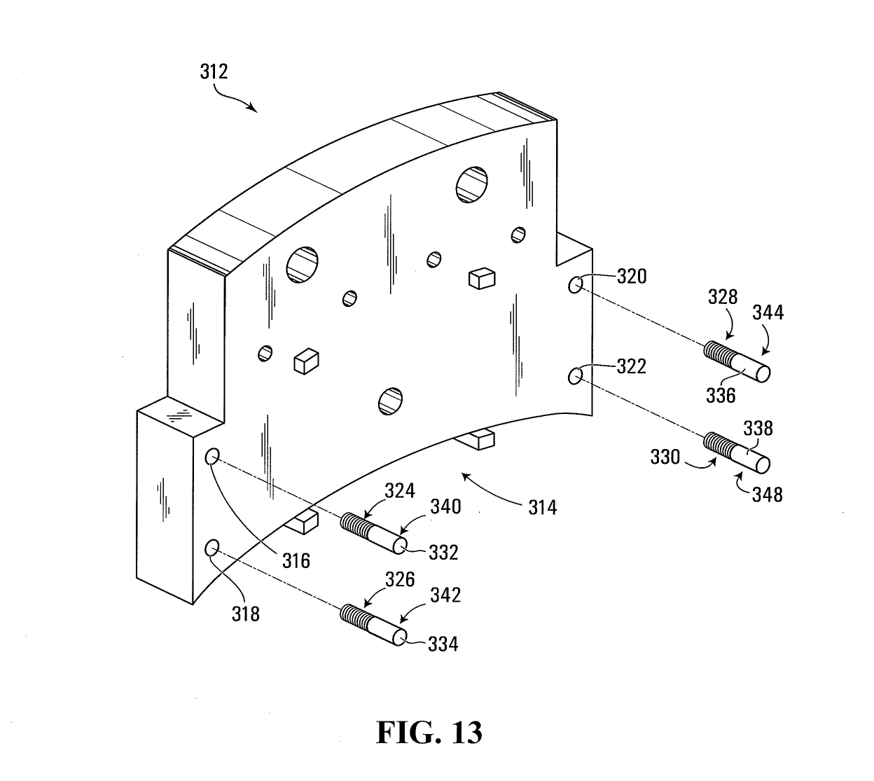

Referring to FIG. 13, a brake body according to another illustrative embodiment is shown generally at 312. The brake body 312 is substantially the same as the first brake body 106, although the brake body 312 does not include transverse elongate recesses to receive keys such as the first and second lateral retainers 152 and 154 (shown in FIGS. 1 to 4 and 8). Instead, on a front side 314 of the brake body 312, the brake body 312 defines threaded openings 316, 318, 320 and 322 to receive respective threaded portions shown generally at 324, 326, 328, and 330 of respective retainer bodies 332, 334, 336, and 338 to attach (or removably connect) the retainer bodies 332, 334, 336, and 338 to the brake body 312. When the threaded portions 324, 326, 328, and 330 are received in the respective threaded openings 316, 318, 320, and 322, retaining portions shown generally at 340, 342, 344, and 348 of the retainer bodies 332, 334, 336, and 338 respectively project away from the brake body 312 and function as lateral retainers to retain a brake shoe (such as the first brake shoe 138 shown in FIGS. 2 and 3 for example) against lateral movement in a direction of movement of an object to be braked, such as the rotatable disc 116 (shown in FIG. 1) for example.

As with the first and second lateral retainers 152 and 154 (shown in FIGS. 1 to 4 and 8), a brake shoe retainer (not shown) may retain a brake shoe (not shown) against the brake body 312 while permitting the brake shoe to be actuated in a brake actuation direction away from the brake body 312. Further, the brake shoe retainer may retain the brake shoe against the brake body 312 with one or more lateral spaces between the brake shoe and one or more of the retainer bodies 332, 334, 336, and 338, while permitting the brake shoe to move towards and contact one or more of the retainer bodies 332, 334, 336, and 338 when the brake shoe is urged in a direction of movement of an object to be braked. The brake shoe therefore may selectively contact one or more of the retainer bodies 332, 334, 336, and 338. Further, the retainer bodies 332, 334, 336, and 338 are connectable to and removable from the brake body 312, and therefore one or more or the retainer bodies 332, 334, 336, and 338 can selectively retain the brake shoe against lateral movement in a direction of movement of an object to be braked (not shown).

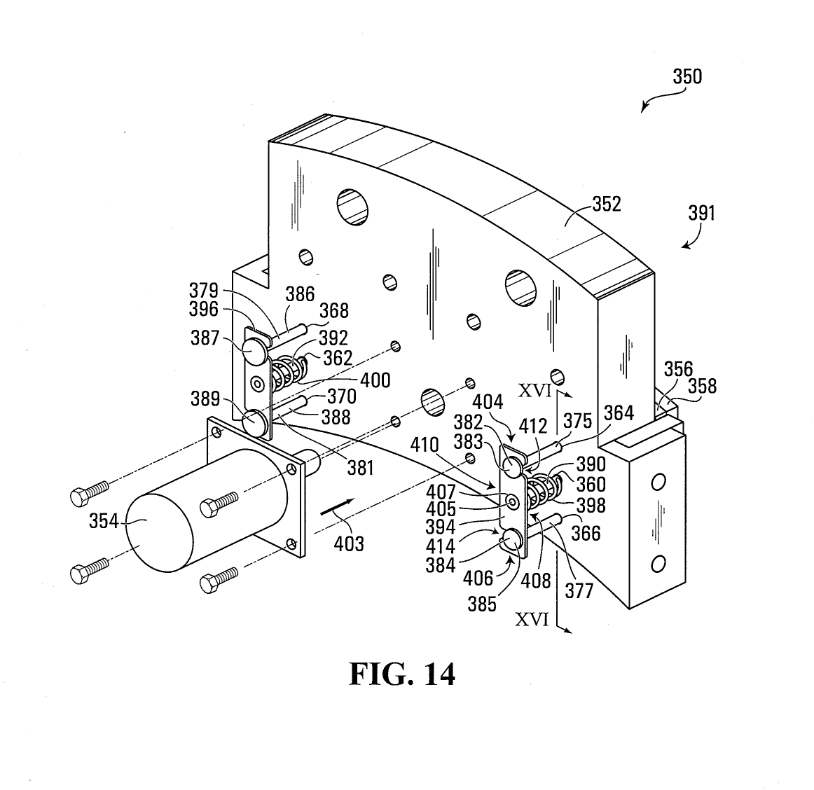

Referring to FIG. 14, a brake assembly according to another illustrative embodiment is shown generally at 350. The brake assembly 350 includes a brake body 352, a brake actuator 354 connectable to the brake body 352, a brake shoe 356, and a brake lining 358. The brake actuator 354 is substantially the same as the brake actuator 160 (shown in FIG. 4 for example). The brake body 352 is substantially the same as the first brake body 106, except that the brake body 352 defines threaded openings 360 and 362, through-openings 364 and 366 on opposite sides of the threaded opening 360, and through-openings 368 and 370 on opposite sides of the threaded opening 362.

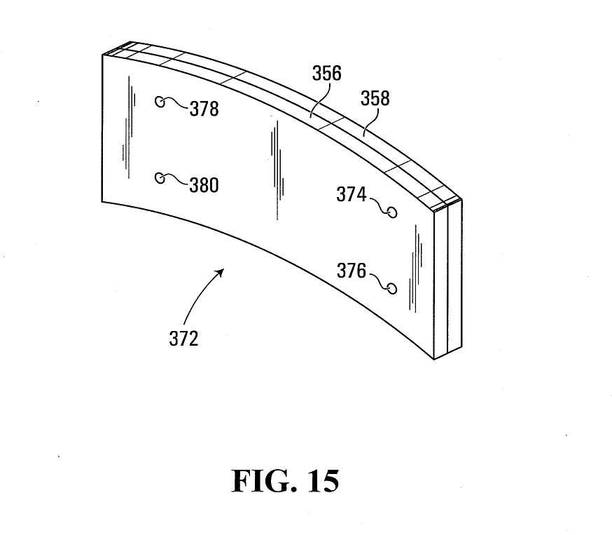

Referring to FIG. 15, the brake shoe 356 and the brake lining 358 are substantially the same as the first brake shoe 138 and the first brake lining 140 (shown in FIGS. 2, 3, and 6 for example) except that on a rear side shown generally at 372, the brake shoe 356 defines threaded openings 374, 376, 378, and 380 in respective spaced apart regions on the rear side 372 of the brake shoe 356.

Referring to FIGS. 14 and 15, the brake assembly 350 also includes brake shoe connectors 382, 384, 386, and 388 having respective shafts 375, 377, 379, and 381 and respective end stops 383, 385, 387, and 389 at respective ends of the respective shafts. The shafts 375, 377, 379, and 381 have respective threaded portions at respective ends opposite the respective end stops 383, 385, 387, and 389.

When the rear side 372 of the brake shoe 356 is retained against a front side 391 of the brake body 352, the threaded openings 374, 376, 378, and 380 are aligned with the through-openings 364, 366, 368, and 370 respectively such that the through-openings 364, 366, 368, and 370 can receive shafts 375, 377, 379, and 381 respectively, and such that the respective threaded portions of the brake shoe connectors 382, 384, 386, and 388 may be threadedly received in the threaded openings 374, 376, 378, and 380 respectively to connect the brake shoe connectors 382, 384, 386, and 388 to the brake shoe 356.

Referring back to FIG. 14, the brake assembly 350 further includes first and second guides 390 and 392 having respective threaded ends threadedly received in the threaded openings 360 and 362 respectively. At respective ends opposite the threaded ends, the first and second guides 390 and 392 are connected to respective first and second force transfer elements 394 and 396. Further, a first coil spring 398 is resiliently compressed between the brake body 352 and the first force transfer element 394, and a second coil spring 400 is resiliently compressed between the brake body 352 and the second force transfer element 396.

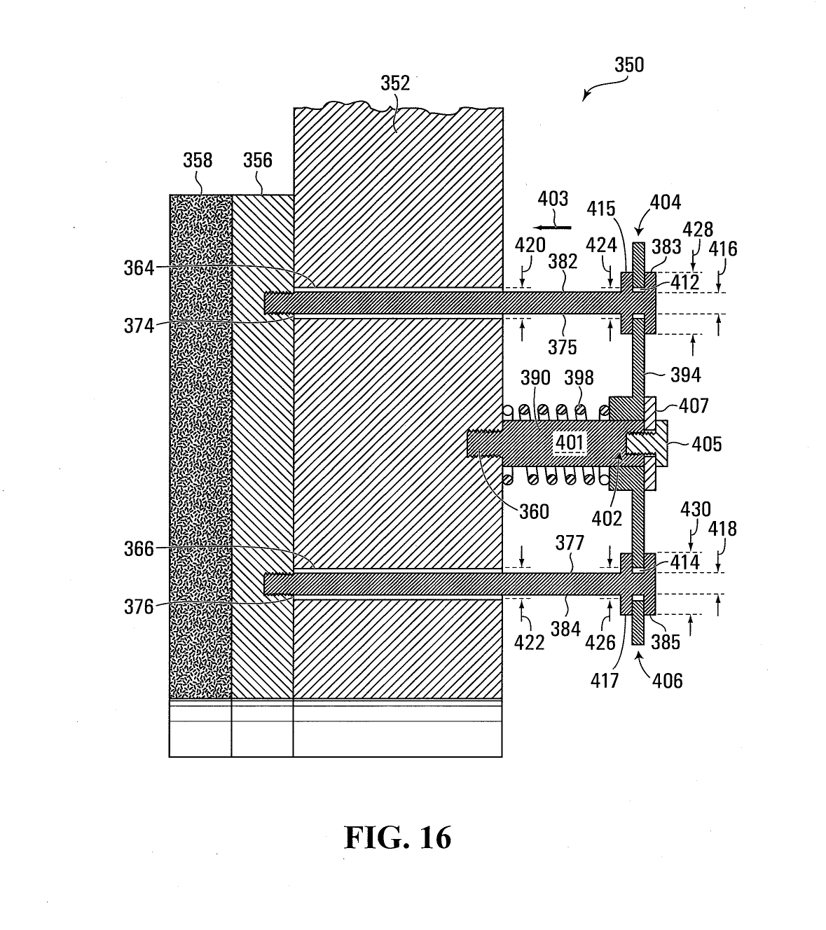

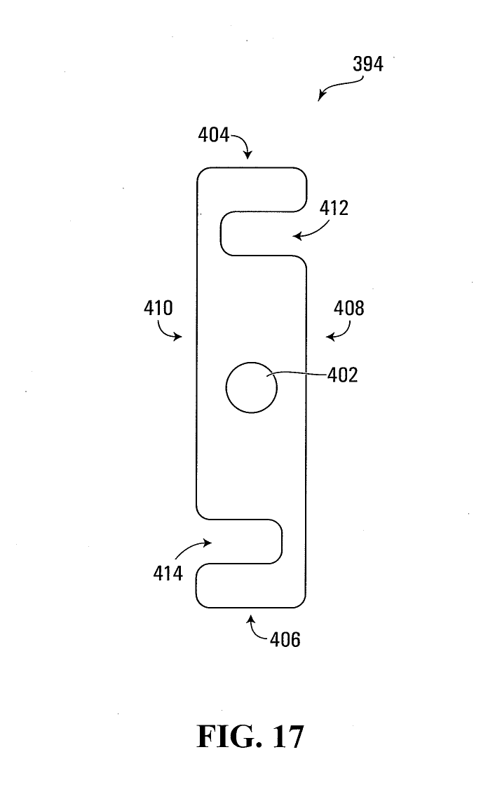

Referring to FIGS. 16 and 17, in the embodiment shown, the first force transfer element 394 defines a central through-opening shown generally at 402 for receiving a portion of the first guide 390. In the embodiment shown, the first guide 390 includes a generally cylindrical post 401, and the through-opening 402 is generally complementary to the post 401. In the embodiment shown, “generally cylindrical” and “generally complementary” mean that the post 401 is sufficiently cylindrical and the through-opening 402 is sufficiently complementary such that the first guide 390 can effectively guide the first force transfer element 394 relative to the brake body 352 in a brake actuation direction shown by the arrow 403 in FIG. 14, and in a direction opposite the brake actuation direction shown by the arrow 403, and such that the first force transfer element 394 is pivotable around a longitudinal axis of the post 401 extending along the brake actuation direction shown by the arrow 403. In the embodiment shown, a bolt 405 and washer 407 retain the first force transfer element 394 in slidable engagement along the post 401.

The first force transfer element 394 has first and second opposite ends shown generally at 404 and 406, and first and second laterally opposite sides shown generally at 408 and 410. Proximate the end 404, the force transfer element 394 defines a through-opening 412 extending to the first side 408. Also, proximate the end 406, the force transfer element 394 defines a through-opening 414 extending to the side 410. Therefore, the shafts 375 and 377 are receivable in and removable from the through openings 412 and 414 respectively in response to rotation of the first force transfer element 394 about the post 401.

The end stops 383 and 385 contact the first force transfer element 394 on an outward-facing side of the first force transfer element 394, and in the embodiment shown the brake shoe connectors 382 and 384 also include respective inner stops 415 and 417 that contact an inward-facing side of the first force transfer element 394 opposite the outward-facing side of the first force transfer element 394. The end stops 383 and 385 and the inner stops 415 and 417 may be threadedly removable and positionable, for example, on the brake shoe connectors 382 and 384 to fit tightly on the opposite outward-facing and inward-facing sides of the first force transfer element 394, thereby securing the brake shoe connectors 382 and 384 in respective positions relative to the first force transfer element 394 to maintain the brake shoe 356 and the brake lining 358 in a generally consistent orientation, which may advantageously distribute braking wear generally evenly over an outer frictional contact surface of the brake lining 358.

The shafts 375 and 377 have respective widths 416 and 418, the through-openings 364 and 366 have respective widths 420 and 422, the through-openings 412 and 414 have respective widths 424 and 426, and the end stops 383 and 385 have respective widths 428 and 430. The widths 424 and 426 are less than the widths 428 and 430, and therefore the brake shoe connectors 382 and 384 are connectable to the first force transfer element 394 because the first force transfer element 394 can retain the end stops 383 and 385 from passing through the through-openings 412 and 414 respectively when the through-openings 412 and 414 receive the shafts 375 and 377 respectively.

Therefore, when the brake shoe connectors 382 and 384 are connected to the first force transfer element 394 and connected to the brake shoe 356 as shown in FIG. 16, the first coil spring 398 resiliently urges the first force transfer element 394 along the longitudinal axis of the post 401 and in the direction opposite the brake actuation direction shown by the arrow 403. The first force transfer element 394 transfers force from the first coil spring 398 to the end stops 383 and 385 of the brake shoe connectors 382 and 384 respectively, and thus through the shafts 375 and 377 to the brake shoe 356. Therefore, the brake shoe connectors 382 and 384, the first guide 390, the first force transfer element 394, and the first coil spring 398 function as a brake shoe retainer to retain the brake shoe 356 against the brake body 352, but the first coil spring 398 is further resiliently compressible to permit the brake shoe 356 to be actuated in the brake actuation direction shown by the arrow 403, away from the brake body 352, to cause an outer frictional contact surface of the brake lining 358 to contact frictionally an object to be braked (not shown).

In the embodiment shown, the brake shoe connectors 382 and 384, the first force transfer element 394, and the first coil spring 398 retain the brake shoe 356 against the brake body 352 with one or both of the first and second lateral spaces between the brake shoe 356 and lateral retainers (such as the first and second lateral retainers 152 and 154 or the retainer bodies 332, 334, 336, and 338 described above, for example).

Further, in the embodiment shown, the widths 424 and 426 are greater than the widths 416 and 418 respectively, and the widths 420 and 422 are also greater than the widths 416 and 418 respectively. Therefore, when the brake shoe connectors 382 and 384 are connected to the brake shoe 356 and connected to the first force transfer element 394, the brake shoe connectors 382 and 384 are movable relative to the first force transfer element 394 to accommodate movement of the brake shoe 356 relative to the first force transfer element 394. Such movement of the brake shoe 356 relative to the first force transfer element 394 may be in a direction of movement of an object to be braked (not shown) in response to the outer frictional contact surface of the brake lining 358 frictionally contacting the object to be braked, as described above for example.

Because the first guide 390 guides first force transfer element 394 along the longitudinal axis of the post 401, and because the brake shoe connectors 382 and 384 are connectable to respective spaced apart regions of the brake shoe 356 on respective opposite sides of the first guide 390, the first force transfer element 394 may advantageously transfer a force from the first coil spring 398 generally evenly to such spaced apart regions of the brake shoe 356. Transferring such a force generally evenly to such spaced apart regions of the brake shoe 356 may tend to urge, the brake shoe 356 in an orientation generally perpendicular to the longitudinal axis of the post 401, which may advantageously prevent misalignment of the brake shoe 356. Further, because the shafts 375 and 377 are receivable in and removable from the through openings 412 and 414 respectively in response to rotation of the first force transfer element 394 about the post 401, a brake shoe retainer including the brake shoe connectors 382 and 384, the first guide 390, the first force transfer element 394, and the first coil spring 398 may advantageously permit a brake shoe to be installed or removed from a brake assembly more efficiently than in other brake assemblies.

The threaded opening 360, the through-openings 368 and 370, the brake shoe connectors 382 and 384, the first guide 390, and the first coil spring 398 are substantially the same as the threaded opening 362, the through-openings 364 and 366, the brake shoe connectors 386 and 388, the second guide 392, and the second coil spring 400 respectively.

Alternative embodiments may differ in numerous ways from those described above. For example, the coil springs described above may be replaced with other springs, or more generally with other resilient bodies. Further, where threads are shown and described above, such threads may be replaced with other fittings or attachment configurations, or with welding, adhesives, or still other alternatives. Still further, alternative embodiments may include two or more brake actuators, and combinations of one or more of the brake shoe retainers described above or other brake shoe retainers.

While specific embodiments of the invention have been described and illustrated, such embodiments should be considered illustrative of the invention only and not as limiting the invention as construed in accordance with the accompanying claims.

What is claimed is:

1. A brake apparatus comprising:
a first brake body;
a first retaining means for retaining a first brake shoe against the first brake body while permitting the first brake shoe to be actuated in a brake actuation direction, away from the first brake body, to cause an outer frictional contact surface of a first brake lining connected to the first brake shoe to contact frictionally an object to be braked; and
a second retaining means for selectively retaining the first brake shoe against lateral movement in a direction of movement of the object to be braked.

2. The apparatus of claim 1 further comprising a means for actuating the first brake shoe in the brake actuation direction.

3. The apparatus of claim 2 wherein the means for actuating comprises a brake piston for transmitting a brake actuation force directly on the first brake shoe.

4. The apparatus of claim 1 wherein the first retaining means comprises a means for resiliently urging the first brake shoe against the first brake body.

5. The apparatus of claim 1 further comprising the first brake shoe.

6. The apparatus of claim 5 wherein the first retaining means is configured to retain the first brake shoe with a lateral space between the first brake shoe and the second retaining means while permitting the first brake shoe to move towards and contact the second retaining means when the first brake shoe is urged in the direction of movement of the object to be braked.

7. The apparatus of claim 1 wherein the second retaining means comprises at least one retainer body removably connectable to the first brake body.

8. The apparatus of claim 7 wherein the at least one retainer body comprises a key having a connecting portion and a retaining portion, and wherein the first brake body defines a recess for attachably receiving the connecting portion to connect the key removably to the first brake body.

9. The apparatus of claim 7 wherein each one of the at least one retainer body comprises a threaded portion and a retaining portion, and wherein the first brake body defines at least one threaded opening for attachably receiving the threaded portion of a respective one of the at least one retainer body to connect the respective one of the at least one retainer body removably to the first brake body.

10. The apparatus of claim 1 wherein the first brake body is configured to permit the first brake shoe to be installed in or removed from the brake apparatus generally in the direction of movement of the object to be braked when the second retaining means does not retain the first brake shoe against lateral movement in the direction of movement of the object to be braked.

11. The apparatus of claim 1 further comprising a brake frame comprising:
the first brake body; and
a second brake body connectable to a second brake shoe connected to a second brake lining having an outer frictional contact surface;
wherein the brake frame defines a recess between the first and second brake bodies, and wherein the first and second brake shoes are positionable in the recess such that the respective outer frictional contact surfaces of the first and second brake linings are opposite each other in the recess generally perpendicular to the brake actuation direction.

12. The apparatus of claim 11 wherein the recess is sized to receive at least a portion of a rotatable disc having first and second generally circular opposite sides, and wherein the first and second brake shoes are positionable in the recess such that the first and second brake linings are positionable apart from the first and second generally circular opposite sides respectively of the rotatable disc when the first brake shoe is not actuated in the brake actuation direction and such that the respective outer frictional contact surfaces of the first and second brake linings are positionable in frictional contact with the first and second generally circular opposite sides respectively of the rotatable disc when the first brake shoe is actuated in the brake actuation direction.

13. The apparatus of claim 11 wherein the frame comprises a means for mounting the frame slidably in a direction generally parallel to the brake actuation direction.

14. A brake apparatus comprising:
a first brake body;
a brake shoe retainer for retaining a first brake shoe against the first brake body while permitting the first brake shoe to be actuated in a brake actuation direction, away from the first brake body, to cause an outer frictional contact surface of a first brake lining connected to the first brake shoe to contact frictionally an object to be braked; and
a lateral retainer for selectively contacting the first brake shoe to retain the first brake shoe selectively against lateral movement in a direction of movement of the object to be braked.

15. The apparatus of claim 14 further comprising an actuator connectable to the first brake body for actuating the first brake shoe in the brake actuation direction.

16. The apparatus of claim 15 wherein the actuator comprises a brake piston for transmitting a brake actuation force directly from the actuator to the first brake shoe.

17. The apparatus of claim 14 wherein the brake shoe retainer is configured to urge the first brake shoe resiliently against the first brake body.

18. The apparatus of claim 14 further comprising the first brake shoe.

19. The apparatus of claim 18 wherein the brake shoe retainer is configured to retain the first brake shoe with a lateral space between the first brake shoe and the lateral retainer while permitting the first brake shoe to move towards and contact the lateral retainer when the first brake shoe is urged in the direction of movement of the object to be braked.

20. The apparatus of claim 14 wherein the lateral retainer comprises at least one retainer body removably connectable to the first brake body.

21. The apparatus of claim 20 wherein the at least one retainer body comprises a key having a connecting portion and a retaining portion, and wherein the first brake body defines a recess for attachably receiving the connecting portion to connect the key removably to the first brake body.

22. The apparatus of claim 20 wherein each one of the at least one retainer body comprises a threaded portion and a retaining portion, and wherein the first brake body defines at least one threaded opening for attachably receiving the threaded portion of a respective one of the at least one retainer body to connect the respective one of the at least one retainer body removably to the first brake body.

23. The apparatus of claim 14 wherein the first brake body is configured to permit the first brake shoe to be installed in or removed from the brake apparatus generally in the direction of movement of the object to be braked when the lateral retainer does not retain the first brake shoe against lateral movement in the direction of movement of the object to be braked.

24. The apparatus of claim 14 further comprising a brake frame comprising:
the first brake body; and
a second brake body connectable to a second brake shoe connected to a second brake lining having an outer frictional contact surface;
wherein the brake frame defines a recess between the first and second brake bodies, and wherein the first and second brake shoes are positionable in the recess such that the respective outer frictional contact surfaces of the first and second brake linings are opposite each other in the recess generally perpendicular to the brake actuation direction.

25. The apparatus of claim 24 wherein the recess is sized to receive at least a portion of a rotatable disc having first and second generally circular opposite sides, and wherein the first and second brake shoes are positionable in the recess such that the first and second brake linings are positionable apart from the first and second generally circular opposite sides respectively of the rotatable disc when the first brake shoe is not actuated in the brake actuation direction and such that the respective outer frictional contact surfaces of the first and second brake linings are positionable in frictional contact with the first and second generally circular opposite sides respectively of the rotatable disc when the first brake shoe is actuated in the brake actuation direction.

26. The apparatus of claim 24 wherein the frame comprises a slide bearing for mounting the frame slidably in a direction generally parallel to the brake actuation direction.

27. A brake shoe retainer apparatus comprising:
first and second brake shoe connectors connectable to respective spaced apart regions of a brake shoe;
a force transfer element connectable to the first and second brake shoe connectors;
a guide connectable to a brake body and configured to guide the force transfer element relative to the brake body in a brake actuation direction and in a direction opposite the brake actuation direction; and
a means for urging the force transfer element in the direction opposite the brake actuation direction.

28. The apparatus of claim 27 wherein:
the first brake connector comprises a first shaft and a first end stop on an end of the first shaft;
the second brake connector comprises a second shaft and a second end stop on an end of the second shaft;
the first and second end stops have respective widths;
the force transfer element has opposite inward-facing and outward-facing surfaces;
the force transfer element defines first and second through-openings, extending between the inward-facing and outward-facing surfaces, for receiving the respective shafts of the first and second brake shoe connectors respectively; and
the first and second through-openings have respective widths less than the widths of the first and second end stops respectively, such that the force transfer element can retain at least respective portions of the first and second end stops against the outward-facing surface to prevent the first and second end stops from passing through the first and second through-openings respectively when the first and second through-openings receive the first and second shafts respectively.

29. The apparatus of claim 28 wherein the width of the first through-opening is greater than a width of the first shaft, and wherein the width of the second through-opening is greater than a width of the second shaft, such that when the first and second brake shoe connectors are connected to the brake shoe and connected to the force transfer element, the first and second brake shoe connectors are movable relative to the force transfer element to accommodate movement of the brake shoe relative to the force transfer element.

30. The apparatus of claim 28 wherein the guide comprises a post having a longitudinal axis, and wherein the force transfer element defines a third through-opening generally complementary to the post.

31. The apparatus of claim 30 wherein the first and second through-openings are on respective opposite ends of the force transfer element, and wherein the third through-opening is between the first and second through-openings.

32. The apparatus of claim 31 wherein the first through-opening extends to a first side of the force transfer element and wherein the second through-opening extends to a second side of the force transfer element opposite the first side of the force transfer element, and wherein the force transfer element is rotatable about the post such that the first and second shafts are receivable in and removable from the first and second through openings respectively in response to rotation of the force transfer element about the post.

33. The apparatus of claim 28 wherein:
the first brake connector further comprises a first inner stop positionable against the inward-facing surface of the force transfer element when the first through-opening receives the first shaft; and
the second brake connector further comprises a second inner stop positionable against the inward-facing surface of the force transfer

34. The apparatus of claim 27 wherein the means for urging comprises a resilient body positionable in contact with the force transfer element and the brake body.

35. The apparatus of claim 34 wherein the resilient body comprises a coil spring positionable around a portion of the guide.
